(19) United States
(12) Patent Application Publication
(10) Pub. No.: US 2023/0215601 A1
(43) Pub. Date: Jul. 6, 2023

(54) Single Pair Ethernet Cable

(71) Applicant: Sterlite Technologies Limited, Haryana (IN)

(72) Inventors: Vaibhav Madha, Haryana (IN); Darshana Bhatt, Haryana (IN)

(21) Appl. No.: 18/147,159

(22) Filed: Dec. 28, 2022

(30) Foreign Application Priority Data
Jan. 3, 2022 (IN) 202241000175

(51) Int. Cl. H01B 11/04; H01B 11/00

(52) U.S. Cl. CPC H01B 11/04; H01B 11/002

(57) ABSTRACT

The present disclosure relates to a cable (100) comprising at least one twisted pair of conductors (102) and a sheath (110) encapsulating the at least one twisted pair of conductors (102). In particular, the at least one twisted pair of conductors (102) has a pair lay length and a pair impedance. Moreover, the at least one twisted pair of conductors (102) has a frequency ratio between 4.77-12.25. Furthermore, the frequency ratio is ratio of the pair impedance to the pair lay length. Further, the cable (100) can operate between 0.1 MHz to 20 MHz. Additionally, the cable (100) is a Single-Pair Ethernet cable. The cable (100) further comprises an insulation layer (104) at least partially covering each conductor of the at least one twisted pair of conductors (102). Additionally, the length of the conductor is 105-115% of cable length.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### CROSS REFERENCE TO RELATED APPLICATION

This application claims the benefit of Indian Patent Application No. 202241000175, entitled “SINGLE PAIR ETHERNET CABLE” filed by the applicant on Jan. 3, 2022, which is incorporated herein by reference in its entirety.

### FIELD

Embodiments of the present disclosure relate to the field of ethernet cables and more particularly, relate to single pair ethernet cables operating between 0.1 MHz-20 MHz frequency.

### BACKGROUND OF THE INVENTION

The use of electronic devices that transmit and/or receive large amounts of data over a communications network such as cameras, televisions and computers continues to proliferate. Data may be transferred to and from these devices by hardwired or wireless connections, or a combination thereof. Devices that are connected to a communications network via a hardwired connection often use so-called Ethernet cables and connectors as these cables and connectors can support high data rate communications with a high level of reliability. Particularly, the ethernet cables are used to transmit broadband signals between modem, router, and computer.

The conventional Ethernet cables have either 2 or 4 pairs of conductors based on the transmission rate. The insulated conductors of each differential pair are tightly twisted about each other to form four twisted pairs of conductors, and these four twisted pairs may be further twisted about each other in a so-called “core twist.” A separator may be provided that is used to separate (and hence reduce coupling between) at least one of the twisted pairs from at least one other of the twisted pairs. The four twisted pairs and any separator may be enclosed in a protective jacket. With technological advancements, Single Pair Ethernet cables have advantageously evolved.

A Single Pair Ethernet cable is a twisted pair of wires where two conductors of a single circuit are twisted together. Single pair Ethernet may refer to Ethernet transmissions over a single twisted pair of wires. The Single Pair Ethernet cables are lean, lightweight, and material saving ethernet cables. Moreover, they enable fast and easy installation and reduce the chances of error in the assembly. The Single Pair Ethernet cables were initially developed to meet the demands of the automotive industry. As technology evolved, the use of Single Pair Ethernet cables spread to various other industries apart from the automotive industry.

The Internet of Things (IOT) is one of the leading industries making use of the benefits of the Single Pair Ethernet cables. The use of Single Pair Ethernet cable helps the network professionals to connect devices to networks.

However, the low frequency operation of the Single Pair Ethernet cable results in return losses due to higher impedance. Particularly, the impedance increases at lower frequencies and results in failure of electrical performance. Also, the higher impedance reduces the output of the Single Pair Ethernet cable.

One of the current solutions to mitigate the problems of return losses in Ethernet cables is to provide a Single Pair Ethernet for the industrial internet of things. In particular, accurate measurement setups have been developed in order to determine the per-unit-length parameters of Single Pair Ethernet (SPE) transmission lines in the frequency range 0 Hz-1.0 GHz. Another solution to the problem of return losses is to provide a Single Pair Ethernet for industrial applications with bandwidth from 0.1-20 MHz.

U.S. patent application Ser. No. 10/135,626B2 titled “Power coupling circuits for single-pair ethernet with automotive applications” discloses power coupling circuits for single-pair Ethernet with automotive applications. In particular, the pair of coupling inductors provides low impedance for DC power and high impedance for data signals.

U.S. patent application Ser. No. 10/665,985B2 titled “Patch cords for reduced-pair Ethernet applications having strain relief units that resist rotational loads and related strain relief units and connectors” discloses a reduced-pair Ethernet patch cords including a twisted pair cable that has a pair of insulated conductors contained within a cable jacket.

However, there are a number of drawbacks in the current technologies providing Single Pair Ethernet with lower return losses and lower impedance values. In particular, the conductors discloses in the prior arts are not insulated using foam or solid solutions. Moreover, the Single Pair Ethernet cable disclosed in the prior arts does not work between 0.1-20 MHz. Furthermore, the impedance is not reduced to operate the Single Pair Ethernet cables disclosed in the prior arts between 0.1-20 MHz.

Accordingly, to overcome the disadvantages of the prior arts, there is a need for a technical solution that overcomes the above-stated limitations in the prior arts. The present disclosure provides a Single Pair Ethernet cable with a lower impedance value.

### SUMMARY OF THE INVENTION

Embodiments of the present disclosure relate to a cable comprising at least one twisted pair of conductors and a sheath encapsulating the at least one twisted pair of conductors. In particular, the at least one twisted pair of conductors has a pair lay length and a pair impedance. Moreover, the at least one twisted pair of conductors has a frequency ratio between 4.77-12.25. Furthermore, the frequency ratio is ratio of the pair impedance to the pair lay length. Further, the cable can operate between 0.1 MHz to 20 MHz.

In accordance with an embodiment of the present disclosure, the cable is a Single-Pair Ethernet cable.

In accordance with an embodiment of the present disclosure, the cable further comprises an insulation layer at least partially covering each conductor of the at least one twisted pair of conductors.

In accordance with an embodiment of the present disclosure, the cable further comprises an insulation layer at least partially covering each conductor of the at least one twisted pair of conductors. In particular, the insulation layer has at least one solid insulation layer and a foam insulation layer.

In accordance with an embodiment of the present disclosure, the cable further comprises an insulation layer at least partially covering each conductor of the at least one twisted pair of conductors. In particular, the insulation layer has at least one layer of polyolefin.

In accordance with an embodiment of the present disclosure, the cable further comprises a first metal layer at least partially covering the at least one twisted pair of conductors.

In accordance with an embodiment of the present disclosure, the cable further comprises a second metal layer at least partially covering the first metal layer. In particular, the second metal layer does not fully cover the first metal layer.

In accordance with an embodiment of the present disclosure, the at least one twisted pair of conductors are twisted such that length of conductor is 105-115% of cable length.

In accordance with an embodiment of the present disclosure, the cable has an impedance greater than or equal to 80Ω.

In accordance with an embodiment of the present disclosure, the frequency ratio is greater than equal to 4.77

The foregoing objectives of the present disclosure are attained by providing single pair ethernet cables operating between 0.1 MHz-20 MHz frequency.

### BRIEF DESCRIPTION OF THE DRAWINGS

So that the manner in which the above-recited features of the present disclosure is understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

The disclosure herein will be better understood from the following description with reference to the drawings, in which:

FIG. 1 is a cross sectional view illustrating a cable in accordance with one embodiment of the present disclosure;

FIG. 2 is a perspective view illustrating a cable showing net like structure surrounding conductors in accordance with one embodiment of the present disclosure.

### ELEMENT LIST

Cable—100
At least one twisted pair of conductors—102
Insulation layer—104
First metal layer—106
Second metal layer—108
Sheath—110
Ripcord—112

The cable is illustrated in the accompanying drawings, which like reference letters indicate corresponding parts in the various figures. It should be noted that the accompanying figure is intended to present illustrations of exemplary embodiments of the present disclosure. This figure is not intended to limit the scope of the present disclosure. It should also be noted that the accompanying figure is not necessarily drawn to scale.

### DETAILED DESCRIPTION OF THE PREFERRED EMBODIMENTS

For a more complete understanding of the present invention, the objects and advantages thereof, reference is now made to the ensuing descriptions.

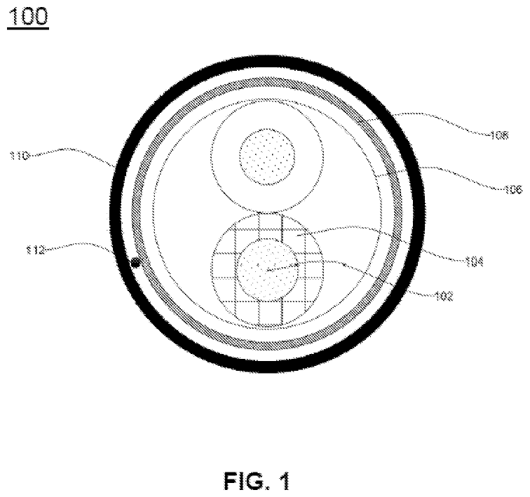

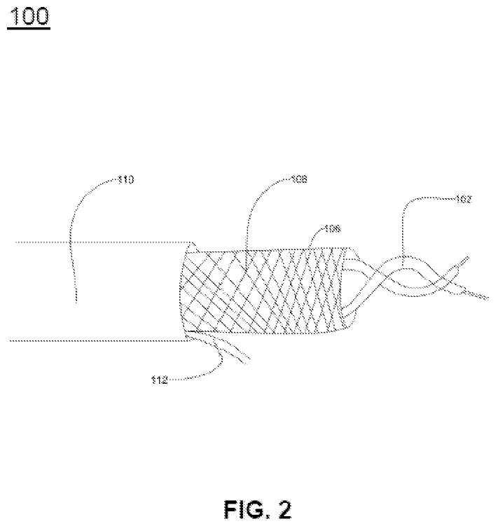

The principles of the present disclosure and their advantages are best understood by referring to FIG. 1 to FIG. 2. In the following detailed description, numerous specific details are set forth in order to provide a thorough understanding of the embodiment of the disclosure as illustrative or exemplary embodiments of the disclosure, specific embodiments in which the disclosure may be practised are described in sufficient detail to enable those skilled in the art to practice the disclosed embodiments. However, it will be obvious to a person skilled in the art that the embodiments of the disclosure may be practised with or without these specific details. In other instances, well-known methods, procedures and components have not been described in detail so as not to unnecessarily obscure aspects of the embodiments of the disclosure.

The following detailed description is, therefore, not to be taken in a limiting sense, and the scope of the present disclosure is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present disclosure.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

The conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The following brief definition of terms shall apply throughout the present disclosure:

Single Pair Ethernet cable carries data and power and uses one pair of wires (or conductors) to transmit data at speeds of up to 10 Mbps (potentially up to 1 Gb/s in the future). In particular, the Single Pair Ethernet is designed for industrial users. Moreover, the single-pair cabling can support up to 52 watts of dc power, covering a range of devices that need both power and data at distances up to 1,000 meters. Furthermore, an ideal range of a Single Pair Ethernet cable to transmit power is 0.1 MHz to 20 MHz.

Low smoke zero halogen jacket (LSZH) is a kind of cable built with a jacket material free from halogenic materials.

Lay length is a distance when one revolution of the conductor is completed.

Insulators are used in electrical equipment to support and separate electrical conductors.

Tighter twisting refers to a pair of conductors twisted tightly such that the area between the conductors is reduced and the length of the conductor is increased.

Pair impedance is based on diameter over dielectric (DoD) and diameter of the conductors. In particular, air gaps produced in between the conductors while twisting and bunching affects the impedance of the pair of conductors.

Frequency ratio is the ratio of the pair impedance to the pair lay length.

Length of the conductor is inversely proportional to the inductance of the cable. In four pair twisted conductors, if the conductors are tightly twisted, the length of the conductor is increased minimally by 9.2%.

Referring to FIG. 1 illustrates a cross sectional view of a cable 100 in accordance with one embodiment of the present disclosure. The cable 100 comprises at least one twisted pair of conductors 102 and a sheath 110 encapsulating the at least one twisted pair of conductors 102. In particular, the at least one twisted pair of conductors 102 has a pair lay length and a pair impedance. Moreover, the at least one twisted pair of conductors 102 has a frequency ratio between 4.77-12.25. Furthermore, the frequency ratio is ratio of the pair impedance to the pair lay length. Further, the cable 100 can operate between 0.1 MHz to 20 MHz.

In accordance with an embodiment of the present disclosure, the cable 100 is a Single-Pair Ethernet cable. Moreover, the cable 100 suffers from return losses at the frequency of 0.1 MHz to 20 MHz. The cable 100 is lean, lightweight and includes material saving Ethernet development. Furthermore, the cable 100 is used in multiple applications such as internet of Things (IoT) applications, Smart City applications and Automation Industries. Further, the cable 100 can be installed faster and easier on site. Additionally, the cable 100 reduces chances of errors in assembly.

In an embodiment, the cable 100 is an Outer Foil Shield/Unshielded Twisted Pair (F/UTP) cable.

The cable 100 comprises at least one twisted pair of conductors 102. Alternatively, there may be more than one pair of conductors 102. In particular, the at least one twisted pair of conductors 102 extend substantially along a longitudinal axis of the cable 100.

In one embodiment, the at least one twisted pair of conductors 102 is helically twisted along a length of the at least one twisted pair of conductors 102. Particularly, the at least one twisted pair of conductors 102 are helically twisted together to minimize cross talk in the cable 100 and for cancelling out electromagnetic interference from internal and external sources.

Moreover, the at least one twisted pair of conductors 102 is characterized by a cross-sectional diameter.

In an embodiment of the present disclosure, the cross-sectional diameter of the at least one twisted pair of conductors 102 is 18-24 AWG. Alternatively, the cross-sectional diameter of each of the at least one twisted pair of conductors 102 may vary.

In another embodiment the at least one twisted pair of conductors 102 is made of copper.

In accordance with an embodiment of the present disclosure, the cable 100 comprises an insulation layer 104. In particular, the insulation layer 104 at least partially covers each conductor of the at least one twisted pair of conductors 102.

In an embodiment, the insulation layer 104 has at least one layer of polyolefin. Moreover, the electric current in the at least one twisted pair of conductors 102 cannot pass through the corresponding insulation layer 104. The insulation layer 104 is a protective coating layer over the corresponding at least one twisted pair of conductors 102. Furthermore, the insulation layer 104 provides electrical isolation for each of the corresponding at least one twisted pair of conductors 102.

In one embodiment, the insulation layer 104 has a thickness. Alternatively, the insulation layer 104 may have any other suitable thickness.

In another embodiment, the insulation layer 104 has at least one solid insulation layer and a foam insulation layer. In particular, the foam insulation layer and the solid insulation layer shield the at least one twisted pair of conductors 102. Moreover, the solid insulation covers the foam insulation. The foam insulation layer shields the at least one twisted pair of conductors 102. Furthermore, the solid insulation layer is provided to protect the foam insulation layer as foam is soft and can be crushed easily.

In accordance with an embodiment of the present disclosure, the cable 100 comprises a first metal layer 106. In particular, the first metal layer 106 at least partially covers the at least one twisted pair of conductors 102. Moreover, the first metal layer 106 includes a shielding of pair with aluminum/PET Tape. The shielding of aluminum tape is used to minimize alien crosstalk. Furthermore, the alien crosstalk is electromagnetic noise occurring in the cable 100 running alongside one or more other signal-carrying cables.

In an embodiment, the cable 100 has a small diameter. Particularly, the shielding of aluminum/PET Tape around the small diameter cable reduces the alien crosstalk.

In accordance with an embodiment of the present disclosure, the cable 100 further comprises a second metal layer 108. In particular, the second metal layer 108 at least partially covers the first metal layer 106. Moreover, the second metal layer 108 does not fully cover the first metal layer 106. Furthermore, the second metal layer 108 has a net like structure to surround the first metal layer 106. Further, the second metal layer 108 has tinned copper braiding. The second metal layer with the tinned copper braiding provides strength and grounding to the cable 100 and eliminates the need for a separate mechanism for grounding the cable 100.

In one embodiment, the braid layer is made of tinned copper to provide tensile strength to the cable 100. The cable 100 becomes lean and strong after providing strength and grounding.

In accordance with an embodiment of the present disclosure, the cable 100 comprises a sheath 110. In particular, the sheath 110 encapsulates the at least one twisted pair of conductors 102. The sheath 110 tightly surrounds the core and reduces the diameter of the cable 100. Moreover, the reduction in diameter helps in easy installation of the cable 100.

In an embodiment of the present disclosure, the sheath 110 is a low smoke zero halogen jacket.

In accordance with an embodiment of the present disclosure, the cable 100 may or may not include one or more ripcords. In particular, the one or more ripcords include a ripcord 112. Alternatively, the cable 100 may include more ripcords.

In one embodiment, the ripcord 112 is placed between the second metal layer 108 and the sheath 110. In particular, the ripcord 112 lies substantially along a longitudinal axis of the cable 100.

In another embodiment, the ripcord 112 facilitates stripping of the sheath 110.

In yet another embodiment of the present disclosure, the ripcord 112 is made of a polyester material. Alternatively, the ripcord 112 may be made of any suitable material.

In yet another embodiment, the ripcord 112 has circular cross-section.

In accordance with an embodiment of the present disclosure, the at least one twisted pair of conductors 102 has a pair lay length and a pair impedance. In particular, the cable 100 includes a single pair of conductors to carry data and power. The twisting of the cable 100 increases with the decrease in the lay length. Moreover, the tighter twisting of the cable 100 increases the length of the at least one twisted pair of conductors 102. Furthermore, the increase in length of the cable 100 improves the electrical performance.

In one embodiment, the increased length of the at least one twisted pair of conductors 102 decreases the inductance of the cable 100.

In another embodiment, the pair lay length must be between 8-18 mm.

In yet another embodiment of the present disclosure, the cable 100 has the pair impedance greater than or equal to 80Ω. If the pair impedance is below the value of 80Ω, return losses will be increased within the defined frequency of 0.1-20 MHz. Alternatively, the pair impedance is between 80-110Ω.

In accordance with an embodiment of the present disclosure, the at least one twisted pair of conductors 102 has a frequency ratio between 4.77-12.25. Alternatively, the frequency ratio is greater than equal to 4.77. In particular, the frequency ratio is below 12.25 for the cable 100 to function efficiently at low frequencies of 0.1-20 MHz.

In an embodiment, the twisting around the at least one twisted pair of conductors 102 is tight to achieve low frequency ratio. The tight twisting of the at least one twisted pair of conductors 102 helps in increasing the length of the conductor. Moreover, the increase in length of the at least one twisted pair of conductors 102 decreases the impedance value and helps achieve the required frequency ratio in the range of 4.77-12.25.

If the frequency ratio value falls in between the range of 4.77-12.25, then the cable 100 performs efficiently without any significant amount of return loss in the low frequency range of 0.1-20 MHz. Alternatively, if the frequency ratio is greater than 12.25, then the return losses in the cable 100 increase which hampers the performance of the cable 100 in low frequency range of 0.1-20 MHz. This means that the cable 100 is not compliant with the TIA 42.7 standard. Moreover, if the frequency ratio is less than 4.77, then the return losses as well as the insertion losses in the cable 100 increase which hampers the performance of the cable 100 in low frequency range of 0.1-20 MHz. This means that the cable 100 is not compliant with the TIA 42.7 standard. Furthermore, the frequency ratio between 4.77 to 12.25 helps in achieving a marginal difference in return loss with respect to TIA 42.7 standard.

In accordance with an embodiment of the present disclosure, the at least one twisted pair of conductors 102 are twisted such that length of conductor is 105-115% of cable length. The twisting around the at least one twisted pair of conductors 102 is tight enough to reduce the area between the at least one twisted pair of conductors 102. Moreover, the tight twisting of the at least one twisted pair of conductors 102 increases the length of the at least one twisted pair of conductors 102 between 5%-15%. Furthermore, the cable 100 faces return losses if the value of the increase in length is less than 5%. Further, the cable 100 faces insertion losses if the value of the length increases more than 15%.

In an embodiment, the at least one twisted pair of conductors 102 helps in reducing the diameter of the cable 100.

In an exemplary example, the conductors are tightly twisted to maintain the frequency ratio between 4.77-12.25 for a 100 mm length of the cable 100. As soon as the ratio is achieved between this range, the conductor length is increased between 105-115 mm.

The present disclosure of the single pair ethernet cable 100 with a lower impedance value provides a number of advantages. The present disclosure provides a cable operating between 0.1 MHz-20 MHz frequency. Moreover, the cable has an impedance to lay length ratio between 4.77 to 12.25 which reduces the return loss at low frequency. Furthermore, the present disclosure minimizes alien crosstalk and provides a cable with small diameter and less weight. Further, the present disclosure provides the cable 100 with good electrical performance and enables easy installation of the cable 100.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

We claim:

1. A cable (100) comprising:
at least one twisted pair of conductors (102), wherein the at least one twisted pair of conductors (102) has a pair lay length and a pair impedance, wherein the at least one twisted pair of conductors (102) has a frequency ratio between 4.77-12.25, wherein the frequency ratio is ratio of the pair impedance to the pair lay length; and
a sheath (110) encapsulating the at least one twisted pair of conductors (102), wherein the cable (100) can operate between 0.1 MHz to 20 MHz.

2. The cable (100) as claimed in claim 1, wherein the cable (100) is a Single-Pair Ethernet cable.

3. The cable (100) as claimed in claim 1, wherein the cable (100) further comprising an insulation layer (104).

4. The cable (100) as claimed in claim 1, wherein the insulation layer (104) at least partially covers each conductor of the at least one twisted pair of conductors (102).

5. The cable (100) as claimed in claim 1, wherein the cable (100) further comprising an insulation layer (104) at least partially covering each conductor of the at least one twisted pair of conductors (102).

6. The cable (100) as claimed in claim 1, wherein the insulation layer (104) has at least one solid insulation layer and a foam insulation layer.

7. The cable (100) as claimed in claim 1, wherein the cable (100) further comprising an insulation layer (104) at least partially covering each conductor of the at least one twisted pair of conductors (102).

8. The cable (100) as claimed in claim 7, wherein the insulation layer (104) has at least one layer of polyolefin.

9. The cable (100) as claimed in claim 1, wherein the cable (100) further comprising a first metal layer (106) at least partially covering the at least one twisted pair of conductors (102).

10. The cable (100) as claimed in claim 6, wherein the cable (100) further comprising a second metal layer (108) at least partially covering the first metal layer (106).

11. The cable (100) as claimed in claim 10, wherein the second metal layer (108) does not fully cover the first metal layer (106).

12. The cable (100) as claimed in claim 1, wherein the at least one twisted pair of conductors (102) are twisted.

13. The cable (100) as claimed in claim 1, wherein length of conductor is 105-115% of cable length.

14. The cable (100) as claimed in claim 1, wherein the cable (100) has an impedance greater than or equal to 80 Ω.

15. The cable (100) as claimed in claim 1, wherein the frequency ratio is greater than equal to 4.77

16. The cable (100) as claimed in claim 1, wherein the cable (100) is an Outer Foil Shield/Unshielded Twisted Pair (F/UTP) cable (100).

17. The cable (100) as claimed in claim 1, wherein cross-sectional diameter of the at least one twisted pair of conductors (102) is in range of 18 AWG to 24 AWG.

18. The cable (100) as claimed in claim 1, wherein the sheath (110) is a low smoke zero halogen jacket (LSZH).

19. The cable (100) as claimed in claim 1, wherein the pair lay length of the at least one twisted pair of conductors (102) is between 8 mm to 18 mm.

20. The cable (100) as claimed in claim 1, wherein the twisting of the at least one twisted pair of conductors (102) increases the length of the at least one twisted pair of conductors (102) between 5% to 15%.
